(19) United States
(12) Patent Application Publication
(10) Pub. No.: US 2007/0173618 A1
(43) Pub. Date: Jul. 26, 2007

(54) Miscible polycarbonate polyester blends

(76) Inventors: Abbas Alli G. Shaikh, Bangalore (IN); Subodh Kumar Pal, Bangalore (IN); Gomatam Raghavan Ravi, Bangalore (IN); Deepak Ramaraju, Bangalore (IN); Ramesh Rajeswaran, Bangalore (IN); Ganesh Kannan, Evansville, IN (US); Xiaodong Shi, Morgantown, WV (US); Huiping Zhang, Evansville, IN (US); Charles Chambers, New Harmony, IN (US)

Correspondence Address: GEAM - O8CV - CPP;IP LEGAL, ONE PLASTICS AVENUE, PITTSFIELD, MA, 01201-3697, US

(21) Appl. No.: 11/336,514

(22) Filed: Jan. 20, 2006

(51) Int. Cl. C08L 69/00

(52) U.S. Cl. 525/466

(57) ABSTRACT

A thermoplastic resin composition is disclosed which includes: structural units derived at least one substituted or unsubstituted polycarbonate, and a polyester comprising structural units derived from at least greater than 40 mole percent of xylene glycol, such that the composition is miscible. Also disclosed is a process of making said thermoplastic compositions and articles derived from said composition. The composition disclosed possess good optical properties, thermal properties and stability.

### BACKGROUND OF THE INVENTION

This invention relates to a miscible thermoplastic resin composition, a method to synthesize the composition and articles made from the compositions.

Polycarbonate is a useful engineering plastic for parts requiring clarity, high toughness, and, in some cases, good heat resistance. However, polycarbonate also has some important deficiencies, among them poor chemical and stress crack resistance, poor resistance to sterilization by gamma radiation, and poor processability. Blends of polyesters with polycarbonates provide thermoplastic compositions having improved properties over those based upon either of the single resins alone. Moreover, such blends are often more cost effective than polycarbonate alone.

Transparent, miscible compositions of any two polymers are rare. The term “miscible”, as used in the specification, refers to compositions that are a mixture on a molecular level wherein intimate polymer-polymer interaction is achieved. Miscible compositions are transparent; not opaque. In addition, differential scanning calorimetry testing detects only a single glass transition temperature (Tg) for miscible blends composed of two or more components. Thus miscibility of PC with the polyesters gives the blends the clarity needed. There have been very few clear polycarbonate/polyester blends developed. U.S. Pat. Nos. 4,619,976 and 4,645,802 disclose clear blends based on bisphenol A polycarbonate with polyesters of poly(1,4-tetramethylene terephthalate), poly(1,4-cyclohexylenedimethylene terephthalate) and selected copolyesters and copoly(ester-imides) of poly(1,4-cyclohexylenedimethylene terephthalate). U.S. Pat. No. 4,786,692 discloses clear blends of bisphenol A polycarbonate and polyesters of terephthalic acid, isophthalic acid, ethylene glycol, and 1,4-cyclohexanedimethanol. U.S. Pat. Nos. 4,188,314 and 4,391,954 disclose clear blends of bisphenol A polycarbonate with poly(1,4-cyclohexylenedimethylene terephthalate-co-isophthalate). These polyester blends do have improved chemical resistance and melt processability, when compared to unblended bisphenol A polycarbonate. However, the good heat resistance and impact strength of bisphenol A polycarbonate blends based on these compositions is reduced significantly. U.S. Pat. No. 4,188,314, U.S. Pat. No. 4,125,572; U.S. Pat. No. 4,391,954; U.S. Pat. No. 4,786,692; U.S. Pat. Nos. 4,897,453, and 5,478,896 relate to blends of an aromatic polycarbonate and poly cyclohexane dimethanol phthalate. U.S. Pat. No. 4,125,572 relates to a blend of polycarbonate, polybutylene terephthalate (PBT) and an aliphatic/cycloaliphatic iso/terephthalate resin. U.S. Pat. No. 6,281,299 discloses a process for manufacturing transparent polyester/polycarbonate compositions, wherein the polyester is fed into the reactor after bisphenol A is polymerized to a polycarbonate.

Clear blends of polycarbonate with polyesters containing less than about 10 mole percent of para-xylene glycol have been disclosed in U.S. Pat. No. 5,942,585 and U.S. Pat. No. 4,564,541. Polyesters modified with of less than about 40 mole percent of any other diol like para-xylene glycol are blended with polycarbonate to give transparent blends have been taught in US2005019784A1 and EP0183141A2. Japanese patents JP07188523 and JP07188525 disclose polycarbonate polyester blends with para-xylene glycol along with impact modifiers like butyl acrylate-glycidyl methacrylate copolymers.

There is a continuing need for polycarbonate polyester blends having a good balance of optical property, and solvent resistance while retaining good mechanical and thermal properties.

### BRIEF DESCRIPTION OF THE INVENTION

According to an embodiment of the present invention, a thermoplastic resin composition is disclosed which includes structural units derived at least one substituted or unsubstituted polycarbonate, and a polyester, wherein the polyester comprising structural units derived from at least greater than 40 mole percent of xylene glycol and wherein the composition is miscible is disclosed. Also disclosed is a method of making said thermoplastic compositions and articles derived from said composition.

Various other features, aspects, and advantages of the present invention will become more apparent with reference to the following description, examples, and appended claims.

### DETAILED DESCRIPTION OF THE INVENTION

The present invention may be understood more readily by reference to the following detailed description of preferred embodiments of the invention and the examples included herein. In this specification and in the claims, which follow, reference will be made to a number of terms which shall be defined to have the following meanings.

The singular forms “a”, “an” and “the” include plural referents unless the context clearly dictates otherwise.

“Optional” or “optionally” means that the subsequently described event or circumstance may or may not occur, and that the description includes instances where the event occurs and instances where it does not.

As used herein the term “polycarbonate” refers to polycarbonates incorporating structural units derived from one or more dihydroxy aromatic compounds and includes copolycarbonates and polyester.

As used herein the term “PCCD” is defined as poly(cyclohexane-1,4-dimethylene cyclohexane-1,4-dicarboxylate).

As used herein the term “BPA” refers to bisphenol A.

“Combination” as used herein includes mixtures, copolymers, reaction products, blends, composites, and the like.

Other than in the operating examples or where otherwise indicated, all numbers or expressions referring to quantities of ingredients, reaction conditions, and the like, used in the specification and claims are to be understood as modified in all instances by the term “about.” Various numerical ranges are disclosed in this patent application. Because these ranges are continuous, they include every value between the minimum and maximum values. Unless expressly indicated otherwise, the various numerical ranges specified in this application are approximations.

As used herein the term “aliphatic radical” refers to a radical having a valence of at least one comprising a linear or branched array of atoms which is not cyclic. The array may include heteroatoms such as nitrogen, sulfur, silicon, selenium and oxygen or may be composed exclusively of carbon and hydrogen. Aliphatic radicals may be “substituted” or “unsubstituted”. A substituted aliphatic radical is defined as an aliphatic radical which comprises at least one substituent. A substituted aliphatic radical may comprise as many substituents as there are positions available on the aliphatic radical for substitution. Substituents which may be present on an aliphatic radical include but are not limited to halogen atoms such as fluorine, chlorine, bromine, and iodine. Substituted aliphatic radicals include trifluoromethyl, hexafluoroisopropylidene, chloromethyl; difluorovinylidene; trichloromethyl, bromoethyl, bromotrimethylene (e.g. —CH₂CHBrCH₂—), and the like. For convenience, the term “unsubstituted aliphatic radical” is defined herein to encompass, as part of the “linear or branched array of atoms which is not cyclic” comprising the unsubstituted aliphatic radical, a wide range of functional groups. Examples of unsubstituted aliphatic radicals include allyl, aminocarbonyl (i.e. —CONH₂), carbonyl, dicyanoisopropylidene (i.e. —CH₂C(CN)₂CH₂—), methyl (i.e. —CH₃), methylene (i.e. —CH₂—), ethyl, ethylene, formyl, hexyl, hexamethylene, hydroxymethyl (i.e. —CH₂OH), mercaptomethyl (i.e. —CH₂SH), methylthio (i.e. —SCH₃), methylthiomethyl (i.e. —CH₂SCH₃), methoxy, methoxycarbonyl, nitromethyl (i.e. —CH₂NO₂), thiocarbonyl, trimethylsilyl, t-butyldimethylsilyl, trimethyoxysilypropyl, vinyl, vinylidene, and the like. Aliphatic radicals are defined to comprise at least one carbon atom. A C₁-C₁₀ aliphatic radical includes substituted aliphatic radicals and unsubstituted aliphatic radicals containing at least one but no more than 10 carbon atoms.

As used herein, the term “aromatic radical” refers to an array of atoms having a valence of at least one comprising at least one aromatic group. The array of atoms having a valence of at least one comprising at least one aromatic group may include heteroatoms such as nitrogen, sulfur, selenium, silicon and oxygen, or may be composed exclusively of carbon and hydrogen. As used herein, the term “aromatic radical” includes but is not limited to phenyl, pyridyl, furanyl, thienyl, naphthyl, phenylene, and biphenyl radicals. As noted, the aromatic radical contains at least one aromatic group. The aromatic group is invariably a cyclic structure having 4n+2 “delocalized” electrons where “n” is an integer equal to 1 or greater, as illustrated by phenyl groups (n=1), thienyl groups (n=1), furanyl groups (n=1), naphthyl groups (n=2), azulenyl groups (n=2), anthraceneyl groups (n=3) and the like. The aromatic radical may also include nonaromatic components. For example, a benzyl group is an aromatic radical which comprises a phenyl ring (the aromatic group) and a methylene group (the nonaromatic component). Similarly a tetrahydronaphthyl radical is an aromatic radical comprising an aromatic group (C₆H₃) fused to a nonaromatic component —(CH₂)₄—. Aromatic radicals may be “substituted” or “unsubstituted”. A substituted aromatic radical is defined as an aromatic radical which comprises at least one substituent. A substituted aromatic radical may comprise as many substituents as there are positions available on the aromatic radical for substitution. Substituents which may be present on an aromatic radical include, but are not limited to halogen atoms such as fluorine, chlorine, bromine, and iodine. Substituted aromatic radicals include trifluoromethylphenyl, hexafluoroisopropylidenebis(4-phenyloxy) (i.e. —OPhC(CF₃)₂PhO—), chloromethylphenyl; 3-trifluorovinyl-2-thienyl; 3-trichloromethylphenyl (i.e. 3-CCl₃Ph—), bromopropylphenyl (i.e. BrCH₂CH₂CH₂Ph—), and the like. For convenience, the term “unsubstituted aromatic radical” is defined herein to encompass, as part of the “array of atoms having a valence of at least one comprising at least one aromatic group”, a wide range of functional groups. Examples of unsubstituted aromatic radicals include 4-allyloxyphenoxy, aminophenyl (i.e. H₂NPh—), aminocarbonylphenyl (i.e. NH₂COPh—), 4-benzoylphenyl, dicyanoisopropylidenebis(4-phenyloxy) (i.e. —OPhC(CN)₂PhO—), 3-methylphenyl, methylenebis(4-phenyloxy) (i.e. —OPhCH₂PhO—), ethylphenyl, phenylethenyl, 3-formyl-2-thienyl, 2-hexyl-5-furanyl; hexamethylene-1,6-bis(4-phenyloxy) (i.e. —OPh(CH₂)₆PhO—); 4-hydroxymethylphenyl (i.e. 4-HOCH₂Ph—), 4-mercaptomethylphemyl (i.e. 4-HSCH₂Ph—), 4-methylthiophenyl (i.e. 4-CH₃SPh—), methoxyphenyl, methoxycarbonylphenyloxy (e.g. methyl salicyl), nitromethylphenyl (i.e. —PhCH₂NO₂), trimethylsilylphenyl, t-butyldimethylsilylphenyl, vinylphenyl, vinylidenebis(phenyl), and the like. The term “a C₃-C₁₀ aromatic radical” includes substituted aromatic radicals and unsubstituted aromatic radicals containing at least three but no more than 10 carbon atoms. The aromatic radical 1-imidazolyl(C₃H₂N₂—) represents a C₃ aromatic radical. The benzyl radical (C₇H₈—) represents a C₇ aromatic radical.

As used herein the term “cycloaliphatic radical” refers to a radical having a valence of at least one, and comprising an array of atoms which is cyclic but which is not aromatic. As defined herein a “cycloaliphatic radical” does not contain an aromatic group. A “cycloaliphatic radical” may comprise one or more noncyclic components. For example, a cyclohexylmethy group (C₆H₁₁CH₂—) is an cycloaliphatic radical which comprises a cyclohexyl ring (the array of atoms which is cyclic but which is not aromatic) and a methylene group (the noncyclic component). The cycloaliphatic radical may include heteroatoms such as nitrogen, sulfur, selenium, silicon and oxygen, or may be composed exclusively of carbon and hydrogen. Cycloaliphatic radicals may be “substituted” or “unsubstituted”. A substituted cycloaliphatic radical is defined as a cycloaliphatic radical which comprises at least one substituent. A substituted cycloaliphatic radical may comprise as many substituents as there are positions available on the cycloaliphatic radical for substitution. Substituents which may be present on a cycloaliphatic radical include but are not limited to halogen atoms such as fluorine, chlorine, bromine, and iodine. Substituted cycloaliphatic radicals include trifluoromethylcyclohexyl, hexafluoroisopropylidenebis(4-cyclohexyloxy) (i.e. —OC₆H₁₁C(CF₃)₂C₆H₁₁—), chloromethylcyclohexyl; 3-trifluorovinyl-2-cyclopropyl; 3-trichloromethylcyclohexyl (i.e. 3-CCl₃C₆H₁₁—), bromopropylcyclohexyl (i.e. BrCH₂CH₂CH₂C₆H₁₁—), and the like. For convenience, the term “unsubstituted cycloaliphatic radical” is defined herein to encompass a wide range of functional groups. Examples of unsubstituted cycloaliphatic radicals include 4-allyloxycyclohexyl, aminocyclohexyl (i.e. H₂N C₆H₁₁—), aminocarbonylcyclopenyl (i.e. NH₂COC₅H₉—), 4-acetyloxycyclohexyl, dicyanoisopropylidenebis(4-cyclohexyloxy) (i.e. —OC₆H₁₁C(CN)₂C₆H₁₁O—), 3-methylcyclohexyl, methylenebis(4-cyclohexyloxy) (i.e. —OC₆H₁₁CH₂C₆H₁₁O—), ethylcyclobutyl, cyclopropylethenyl, 3-formyl-2-terahydrofuranyl, 2-hexyl-5-tetrahydrofuranyl; hexamethylene-1,6-bis(4-cyclohexyloxy) (i.e. —OC₆H₁₁(CH₂)₆ C₆H₁₁O—); 4-hydroxymethylcyclohexyl (i.e. 4-HOCH₂C₆H₁₁—), 4-mercaptomethylcyclohexyl (i.e. 4-HSCH₂C₆H₁₁—), 4-methylthiocyclohexyl (i.e. 4-CH₃SC₆H₁₁—), 4-methoxycyclohexyl, 2-methoxycarbonylcyclohexyloxy(2-CH₃OCO C₆H₁₁—), nitromethylcyclohexyl (i.e. NO₂CH₂C₆H₁₀—), trimethylsilylcyclohexyl, t-butyldimethylsilylcyclopentyl, 4-trimethoxysilyethylcyclohexyl (e.g. (CH₃O)₃SiCH₂CH₂C₆H₁₀—), vinylcyclohexenyl, vinylidenebis(cyclohexyl), and the like. The term “a C₃-C₁₀ cycloaliphatic radical” includes substituted cycloaliphatic radicals and unsubstituted cycloaliphatic radicals containing at least three but no more than 10 carbon atoms. The cycloaliphatic radical 2-tetrahydrofuranyl(C₄H₇O—) represents a C₄ cycloaliphatic radical. The cyclohexylmethyl radical (C₆H₁₁CH₂—) represents a C₇ cycloaliphatic radical.

According to an embodiment of the present invention, a thermoplastic resin composition includes structural units derived at least one substituted or unsubstituted polycarbonate, and a polyester comprising structural units derived from at least greater than 40 mole percent of xylene glycol and wherein the composition is miscible is disclosed. Also disclosed is a method of making said thermoplastic compositions and articles derived from said composition.

A component of the composition of the invention is an aromatic polycarbonate. The aromatic polycarbonate resins suitable for use in the present invention, methods of making polycarbonate resins and the use of polycarbonate resins in thermoplastic molding compounds are well known in the art, see, generally, U.S. Pat. Nos. 3,169,121, 4,487,896 and 5,411,999, the respective disclosures of which are each incorporated herein by reference.

Polycarbonates useful in the invention comprise repeating units of the formula (I) 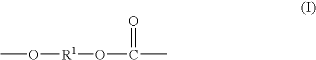
wherein R¹ is a divalent aromatic radical derived from a dihydroxyaromatic compound of the formula HO-D-OH, wherein D has the structure of formula: 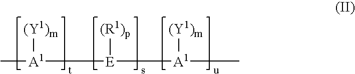
wherein A¹ represents an aromatic group including, but not limited to, phenylene, biphenylene, naphthylene, and the like. In some embodiments E may be an alkylene or alkylidene group including, but not limited to, methylene, ethylene, ethylidene, propylene, propylidene, isopropylidene, butylene, butylidene, isobutylidene, amylene, amylidene, isoamylidene, and the like. In other embodiments when E is an alkylene or alkylidene group, it may also consist of two or more alkylene or alkylidene groups connected by a moiety different from alkylene or alkylidene, including, but not limited to, an aromatic linkage; a tertiary nitrogen linkage; an ether linkage; a carbonyl linkage; a silicon-containing linkage, silane, siloxy; or a sulfur-containing linkage including, but not limited to, sulfide, sulfoxide, sulfone, and the like; or a phosphorus-containing linkage including, but not limited to, phosphinyl, phosphonyl, and the like. In other embodiments E may be a cycloaliphatic group including, but not limited to, cyclopentylidene, cyclohexylidene, 3,3,5-trimethylcyclohexylidene, methylcyclohexylidene, 2-[2.2.1]-bicycloheptylidene, neopentylidene, cyclopentadecylidene, cyclododecylidene, adamantylidene, and the like; a sulfur-containing linkage, including, but not limited to, sulfide, sulfoxide or sulfone; a phosphorus-containing linkage, including, but not limited to, phosphinyl or phosphonyl; an ether linkage; a carbonyl group; a tertiary nitrogen group; or a silicon-containing linkage including, but not limited to, silane or siloxy. R¹ independently at each occurrence comprises a monovalent hydrocarbon group including, but not limited to, alkenyl, allyl, alkyl, aryl, aralkyl, alkaryl, or cycloalkyl. In various embodiments a monovalent hydrocarbon group of R¹ may be halogen-substituted, particularly fluoro- or chloro-substituted, for example as in dichloroalkylidene, particularly gem-dichloroalkylidene. Y¹ independently at each occurrence may be an inorganic atom including, but not limited to, halogen (fluorine, bromine, chlorine, iodine); an inorganic group containing more than one inorganic atom including, but not limited to, nitro; an organic group including, but not limited to, a monovalent hydrocarbon group including, but not limited to, alkenyl, allyl, alkyl, aryl, aralkyl, alkaryl, or cycloalkyl, or an oxy group including, but not limited to, OR² wherein R² is a monovalent hydrocarbon group including, but not limited to, alkyl, aryl, aralkyl, alkaryl, or cycloalkyl; it being only necessary that Y¹ be inert to and unaffected by the reactants and reaction conditions used to prepare the polymer. In some particular embodiments Y¹ comprises a halo group or C₁-C₆ alkyl group. The letter “m” represents any integer from and including zero through the number of replaceable hydrogens on A¹ available for substitution; “p” represents an integer from and including zero through the number of replaceable hydrogens on E available for substitution; “t” represents an integer equal to at least one; “s” represents an integer equal to either zero or one; and “u” represents any integer including zero.

In dihydroxy-substituted aromatic hydrocarbons in which D is represented by formula (II) above, when more than one Y¹ substituent is present, they may be the same or different. The same holds true for the R¹ substituent. Where “s” is zero in formula (II) and “u” is not zero, the aromatic rings are directly joined by a covalent bond with no intervening alkylidene or other bridge. The positions of the hydroxyl groups and Y¹ on the aromatic nuclear residues A¹ can be varied in the ortho, meta, or para positions and the groupings can be in vicinal, asymmetrical or symmetrical relationship, where two or more ring carbon atoms of the hydrocarbon residue are substituted with Y¹ and hydroxyl groups. In some particular embodiments the parameters “t”, “s”, and “u” each have the value of one; both A¹ radicals are unsubstituted phenylene radicals; and E is an alkylidene group such as isopropylidene. In some particular embodiments both A¹ radicals are p-phenylene, although both may be o- or m-phenylene or one o- or m-phenylene and the other p-phenylene.

In some embodiments of dihydroxy-substituted aromatic hydrocarbons E may be an unsaturated alkylidene group. Suitable dihydroxy-substituted aromatic hydrocarbons of this type include those of the formula (III): 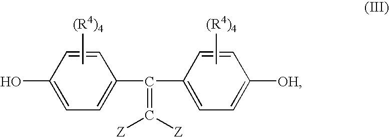
where independently each R⁴ is hydrogen, chlorine, bromine or a C₁₋₃₀ monovalent hydrocarbon or hydrocarbonoxy group, each Z is hydrogen, chlorine or bromine, subject to the provision that at least one Z is chlorine or bromine.

Suitable dihydroxy-substituted aromatic hydrocarbons also include those of the formula (IV): 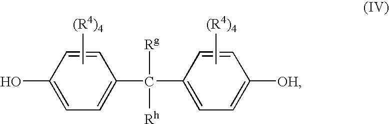
where independently each R4 is as defined hereinbefore, and independently Rg and Rh are hydrogen or a C1-30 hydrocarbon group.

In some embodiments of the present invention, dihydroxy-substituted aromatic hydrocarbons that may be used comprise those disclosed by name or formula (generic or specific) in U.S. Pat. Nos. 2,991,273, 2,999,835, 3,028,365, 3,148,172, 3,153,008, 3,271,367, 3,271,368, and 4,217,438. In other embodiments of the invention, dihydroxy-substituted aromatic hydrocarbons comprise bis(4-hydroxyphenyl)sulfide, bis(4-hydroxyphenyl)ether, bis(4-hydroxyphenyl)sulfone, bis(4-hydroxyphenyl)sulfoxide, 1,4-dihydroxybenzene, 4,4′-oxydiphenol, 2,2-bis(4-hydroxyphenyl)hexafluoropropane, 4,4′-(3,3,5-trimethylcyclohexylidene)diphenol; 4,4′-bis(3,5-dimethyl)diphenol, 1,1-bis(4-hydroxy-3-methylphenyl)cyclohexane; 4,4-bis(4-hydroxyphenyl)heptane; 2,4′-dihydroxydiphenylmethane; bis(2-hydroxyphenyl)methane; bis(4-hydroxyphenyl)methane; bis(4-hydroxy-5-nitrophenyl)methane; bis(4-hydroxy-2,6-dimethyl-3-methoxyphenyl)methane; 1,1-bis(4-hydroxyphenyl)ethane; 1,2-bis(4-hydroxyphenyl)ethane; 1,1-bis(4-hydroxy-2-chlorophenyl)ethane; 2,2-bis(3-phenyl-4-hydroxyphenyl)propane; 2,2-bis(4-hydroxy-3-methylphenyl)propane; 2,2-bis(4-hydroxy-3-ethylphenyl)propane; 2,2-bis(4-hydroxy-3-isopropylphenyl)propane; 2,2-bis(4-hydroxy-3,5-dimethylphenyl)propane; 3,5,3′,5′-tetrachloro-4,4′-dihydroxyphenyl)propane; bis(4-hydroxyphenyl)cyclohexylmethane; 2,2-bis(4-hydroxyphenyl)-1-phenylpropane; 2,4′-dihydroxyphenyl sulfone; dihydroxy naphthalene; 2,6-dihydroxy naphthalene; hydroquinone; resorcinol; C₁₋₃ alkyl-substituted resorcinols; methyl resorcinol, catechol, 1,4-dihydroxy-3-methylbenzene; 2,2-bis(4-hydroxyphenyl)butane; 2,2-bis(4-hydroxyphenyl)-2-methylbutane; 1,1-bis(4-hydroxyphenyl)cyclohexane; 4,4′-dihydroxydiphenyl; 2-(3-methyl-4-hydroxyphenyl-2-(4-hydroxyphenyl)propane; 2-(3,5-dimethyl-4-hydroxyphenyl)-2-(4-hydroxyphenyl)propane; 2-(3-methyl-4-hydroxyphenyl)-2-(3,5-dimethyl-4-hydroxyphenyl)propane; bis(3,5-dimethylphenyl-4-hydroxyphenyl)methane; 1,1-bis(3,5-dimethylphenyl-4-hydroxyphenyl)ethane; 2,2-bis(3,5-dimethylphenyl-4-hydroxyphenyl)propane; 2,4-bis(3,5-dimethylphenyl-4-hydroxyphenyl)-2-methylbutane; 3,3-bis(3,5-dimethylphenyl-4-hydroxyphenyl)pentane; 1,1-bis(3,5-dimethylphenyl-4-hydroxyphenyl)cyclopentane; 1,1-bis(3,5-dimethylphenyl-4-hydroxyphenyl)cyclohexane; bis(3,5-dimethyl-4-hydroxyphenyl) sulfoxide, bis(3,5-dimethyl-4-hydroxyphenyl)sulfone and bis(3,5-dimethylphenyl-4-hydroxyphenyl)sulfide. In a particular embodiment the dihydroxy-substituted aromatic hydrocarbon comprises bisphenol A.

In some embodiments of dihydroxy-substituted aromatic hydrocarbons when E is an alkylene or alkylidene group, said group may be part of one or more fused rings attached to one or more aromatic groups bearing one hydroxy substituent. Suitable dihydroxy-substituted aromatic hydrocarbons of this type include those containing indane structural units such as represented by the formula (V), which compound is 3-(4-hydroxyphenyl)-1,1,3-trimethylindan-5-ol, and by the formula (VI), which compound is 1-(4-hydroxyphenyl)-1,3,3-trimethylindan-5-ol:

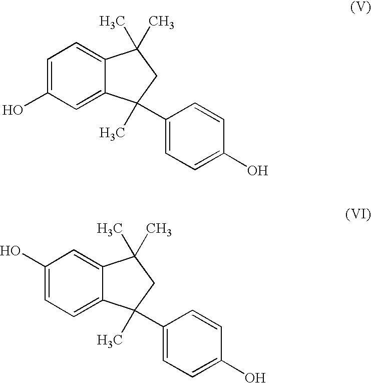

Also included among suitable dihydroxy-substituted aromatic hydrocarbons of the type comprising one or more alkylene or alkylidene groups as part of fused rings are the 2,2,2′,2′-tetrahydro-1,1′-spirobi[1H-indene]diols having formula (VII): 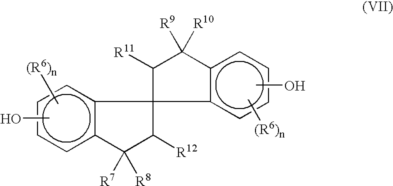
wherein each R⁶ is independently selected from monovalent hydrocarbon radicals and halogen radicals; each R⁷, R⁸, R⁹, and R¹⁰ is independently C₁₋₆ alkyl; each R¹¹ and R¹² is independently H or C₁₋₆ alkyl; and each n is independently selected from positive integers having a value of from 0 to 3 inclusive. In a particular embodiment the 2,2,2′,2′-tetrahydro-1,1′-spirobi[1H-indene]diol is 2,2,2′,2′-tetrahydro-3,3,3′,3′-tetramethyl-1,1′-spirobi[1H-indene]-6,6′-diol (sometimes known as “SBI”). Mixtures of alkali metal salts derived from mixtures of any of the foregoing dihydroxy-substituted aromatic hydrocarbons may also be employed.

The term “alkyl” as used in the various embodiments of the present invention is intended to designate both linear alkyl, branched alkyl, aralkyl, cycloalkyl, bicycloalkyl, tricycloalkyl and polycycloalkyl radicals containing carbon and hydrogen atoms, and optionally containing atoms in addition to carbon and hydrogen, for example atoms selected from Groups 15, 16 and 17 of the Periodic Table. The term “alkyl” also encompasses that alkyl portion of alkoxide groups. In various embodiments normal and branched alkyl radicals are those containing from 1 to about 32 carbon atoms, and include as illustrative non-limiting examples C₁-C₃₂ alkyl optionally substituted with one or more groups selected from C₁-C₃₂ alkyl, C₃-C₁₅ cycloalkyl or aryl; and C₃-C₁₅ cycloalkyl optionally substituted with one or more groups selected from C₁-C₃₂ alkyl. Some particular illustrative examples comprise methyl, ethyl, n-propyl, isopropyl, n-butyl, sec-butyl, tertiary-butyl, pentyl, neopentyl, hexyl, heptyl, octyl, nonyl, decyl, undecyl and dodecyl. Some illustrative non-limiting examples of cycloalkyl and bicycloalkyl radicals include cyclobutyl, cyclopentyl, cyclohexyl, methylcyclohexyl, cycloheptyl, bicycloheptyl and adamantyl. In various embodiments aralkyl radicals are those containing from 7 to about 14 carbon atoms; these include, but are not limited to, benzyl, phenylbutyl, phenylpropyl, and phenylethyl. In various embodiments aryl radicals used in the various embodiments of the present invention are those substituted or unsubstituted aryl radicals containing from 6 to 18 ring carbon atoms. Some illustrative non-limiting examples of these aryl radicals include C6-C15 aryl optionally substituted with one or more groups selected from C1-C32 alkyl, C3-C15 cycloalkyl or aryl. Some particular illustrative examples of aryl radicals comprise substituted or unsubstituted phenyl, biphenyl, toluyl and naphthyl.

Mixtures comprising two or more hydroxy-substituted hydrocarbons may also be employed. In some particular embodiments mixtures of at least two monohydroxy-substituted alkyl hydrocarbons, or mixtures of at least one monohydroxy-substituted alkyl hydrocarbon and at least one dihydroxy-substituted alkyl hydrocarbon, or mixtures of at least two dihydroxy-substituted alkyl hydrocarbons, or mixtures of at least two monohydroxy-substituted aromatic hydrocarbons, or mixtures of at least two dihydroxy-substituted aromatic hydrocarbons, or mixtures of at least one monohydroxy-substituted aromatic hydrocarbon and at least one dihydroxy-substituted aromatic hydrocarbon, or mixtures of at least one monohydroxy-substituted alkyl hydrocarbon and at least one dihydroxy-substituted aromatic hydrocarbon may be employed.

In yet another, the polycarbonate resin is a linear polycarbonate resin that is derived from bisphenol A and phosgene. In an alternative embodiment, the polycarbonate resin is a blend of two or more polycarbonate resins.

The aromatic polycarbonate may be prepared in the melt, in solution, or by interfacial polymerization techniques well known in the art. For example, the aromatic polycarbonates can be made by reacting bisphenol-A with phosgene, dibutyl carbonate or diphenyl carbonate. Such aromatic polycarbonates are also commercially available. In one embodiment, the aromatic polycarbonate resins are commercially available from General Electric Company, e.g., LEXAN™ bisphenol A-type polycarbonate resins.

The preferred polycarbonates are preferably high molecular weight aromatic carbonate polymers have an intrinsic viscosity (as measured in methylene chloride at 25° C.) ranging from about 0.30 to about 1.00 deciliters per gram. Polycarbonates may be branched or unbranched and generally will have a weight average molecular weight of from about 10,000 to about 200,000, preferably from about 20,000 to about 100,000 as measured by gel permeation chromatography. It is contemplated that the polycarbonate may have various known end groups.

Typically such polyester resins include crystalline polyester resins such as polyester resins derived from an aliphatic or cycloaliphatic diol, or mixtures thereof, containing from 2 to about 20 carbon atoms and at least one aromatic dicarboxylic acid. Preferred polyesters are derived from an aliphatic diol and an aromatic dicarboxylic acid and have repeating units according to structural formula (VIII) 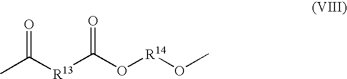
wherein, R¹³ and R¹⁴ are independently at each occurrence a monovalent hydrocarbon group, aliphatic, aromatic and cycloaliphatic radical. In one embodiment R¹⁴ is an alkyl radical compromising a dehydroxylated residue derived from an aliphatic or cycloaliphatic diol, or mixtures thereof, containing from 2 to about 20 carbon atoms and R¹³ is an aromatic radical comprising a decarboxylated residue derived from an aromatic dicarboxylic acid. The polyester is a condensation product where R¹⁴ is the residue of an aromatic, aliphatic or cycloaliphatic radical containing diol having C₁ to C₃₀ carbon atoms or chemical equivalent thereof, and R¹³ is the decarboxylated residue derived from an aromatic, aliphatic or cycloaliphatic radical containing diacid of C₁ to C₃₀ carbon atoms or chemical equivalent thereof. The polyester resins are typically obtained through the condensation or ester interchange polymerization of the diol or diol equivalent component with the diacid or diacid chemical equivalent component.

The diacids meant to include carboxylic acids having two carboxyl groups each useful in the preparation of the polyester resins of the present invention are preferably aliphatic, aromatic, cycloaliphatic. Examples of diacids are cyclo or bicyclo aliphatic acids, for example, decahydro naphthalene dicarboxylic acids, stilbene dicarboxylic acid, norbornene dicarboxylic acids, bicyclo octane dicarboxylic acids, 1,4-cyclohexanedicarboxylic acid or chemical equivalents, and most preferred is trans-1,4-cyclohexanedicarboxylic acid or a chemical equivalent. Linear dicarboxylic acids like adipic acid, azelaic acid, dicarboxyl dodecanoic acid, and succinic acid may also be useful. Chemical equivalents of these diacids include esters, aliphatic esters, e.g., dialiphatic esters, diaromatic esters, anhydrides, salts, acid chlorides, acid bromides, and the like. Examples of aromatic dicarboxylic acids from which the decarboxylated residue R¹ may be derived are acids that contain a single aromatic ring per molecule such as, e.g., isophthalic or terephthalic acid, 1,2-di(p-carboxyphenyl)ethane, 4,4′-dicarboxydiphenyl ether, 4,4′-bisbenzoic acid and mixtures thereof, as well as acids contain fused rings such as, e.g. 1,4-, 1,5-, or 2,6-naphthalene dicarboxylic acids. Preferred dicarboxylic acids include terephthalic acid, isophthalic acid, stilbene dicarboxylic acids, naphthalene dicarboxylic acids, and the like, and mixtures comprising at least one of the foregoing dicarboxylic acids.

Examples of the polyvalent carboxylic acid include, but are not limited to, an aromatic polyvalent carboxylic acid, an aromatic oxycarboxylic acid, an aliphatic dicarboxylic acid, and an alicyclic dicarboxylic acid, including terephthalic acid, isophthalic acid, ortho-phthalic acid, 1,5-naphthalenedicarboxyli acid, 2,6-naphthalenedicarboxylic acid, diphenic acid, sulfoterephthalic acid, 5-sulfoisophthalic acid, 4-sulfophthalic acid, 4-sulfonaphthalene 2,7-dicarboxylic acid, 5-[4-sulfophenoxy] isophthalic acid, sulfoterephthalic acid, p-oxybenzoic acid, p-(hydroxyethoxy)benzoic acid, succinic acid, adipic acid, azelaic acid, sebacic acid, dodecanedicarboxylic acid, fumaric acid, maleic acid, itaconic acid, hexahydrophthalic acid, tetrahydrophthalic acid, trimellitic acid, trimesic acid, and pyrromellitic acid. These may be used in the form of metal salts and ammonium salts and the like.

In one embodiment of the present invention the polyester is derived from structural units comprising xylene glycol. In one embodiment of the present invention the polyester is derived from structural units comprising at least one selected from the group consisting of ortho-xylene glycol, meta-xylene glycol, and para-xylene glycol. In one embodiment of the present invention the polyester is derived from structural units comprising para-xylene glycol. In one embodiment the xylene glycol is present in an amount at least greater than about 40 mole percent. In another embodiment the xylene glycol is present in an amount from about 50 to 100 mole percent. In yet another embodiment the xylene glycol is about 100 mole percent.

In one embodiment the polyester may optionally comprise straight chain, branched, or cycloaliphatic diols containing from 2 to 12 carbon atoms. Examples of such diols include but are not limited to ethylene glycol; propylene glycol, i.e., 1,2- and 1,3-propylene glycol; 2,2-dimethyl-1,3-propane diol; 2-ethyl, 2-methyl, 1,3-propane diol; 1,3- and 1,5-pentane diol; dipropylene glycol; 2-methyl-1,5-pentane diol; 1,6-hexane diol; dimethanol decalin, dimethanol bicyclo octane; 1,4-cyclohexane dimethanol and particularly its cis- and trans-isomers; triethylene glycol; 1,10-decane diol; and mixtures of any of the foregoing. In one embodiment the diol include glycols, such as ethylene glycol, propylene glycol, butanediol, hydroquinone, resorcinol, trimethylene glycol, 2-methyl-1,3-propane glycol, 1,4-butanediol, hexamethylene glycol, decamethylene glycol, 1,4-cyclohexane dimethanol, or neopentylene glycol. Chemical equivalents to the diols include esters, such as dialkylesters, diaryl esters, and the like.

In one embodiment the polyester may optionally comprise polyvalent alcohols which include, but are not limited to, an aliphatic polyvalent alcohol, an alicyclic polyvalent alcohol, and an aromatic polyvalent alcohol, including ethylene glycol, propylene glycol, 1,3-propanediol, 2,3-butanediol, 1,4-butanediol, 1,5-pentanediol, 1,6-hexanediol, neopentyl glycol, diethylene glycol, dipropylene glycol, 2,2,4-trimethyl-1,3-pentanediol, polyethylene glycol, polypropylene glycol, polytetramethylene glycol, trimethylolethane, trimethylolpropane, glycerin, pentaerythritol, 1,4-cyclohexanediol, 1,4-cyclohexanedimethanol, spiroglycol, tricyclodecanediol, tricyclodecanedimethanol, m-xylene glycol, o-xylene glycol, 1,4-phenylene glycol, bisphenol A, lactone polyester and polyols. Further, with respect to the polyester resin obtained by polymerizing the polybasic carboxylic acids and the polyhydric alcohols either singly or in combination respectively, a resin obtained by capping the polar group in the end of the polymer chain using an ordinary compound capable of capping an end can also be used.

Preferred polyesters are obtained by copolymerizing para-xylene glycol component and an acid component comprising at least about 0.1 mole %, preferably at least about 95 mole %, of terephthalic acid, or polyester-forming derivatives thereof. The preferred glycol, para-xylene glycol, component can contain up to about 100 mole %, preferably up to about 5 mole % of another glycol, such as ethylene glycol, trimethylene glycol, 2-methyl-1,3-propane glycol, hexamethylene glycol, decamethylene glycol, cyclohexane dimethanol, neopentylene glycol, and the like, and mixtures comprising at least one of the foregoing glycols. The preferred acid component may contain up to about 100 mole %, preferably up to about 50 mole %, of another acid such as isophthalic acid, 2,6-naphthalene dicarboxylic acid, 2,7-naphthalene dicarboxylic acid, 1,5-naphthalene dicarboxylic acid, 4,4′-diphenyl dicarboxylic acid, 4,4′-diphenoxyethanedicarboxylic acid, sebacic acid, adipic acid, and the like, and polyester-forming derivatives thereof, and mixtures comprising at least one of the foregoing acids or acid derivatives.

Block copolyester resin components are also useful, and can be prepared by the transesterification of (a) straight or branched chain poly(alkylene terephthalate) and (b) a copolyester of a linear aliphatic dicarboxylic acid and, optionally, an aromatic dibasic acid such as terephthalic or isophthalic acid with one or more straight or branched chain dihydric aliphatic glycols. Especially useful when high melt strength is important are branched high melt viscosity resins, which include a small amount of, e.g., up to 5 mole percent based on the acid units of a branching component containing at least three ester forming groups. The branching component can be one that provides branching in the acid unit portion of the polyester, in the glycol unit portion, or it can be a hybrid branching agent that includes both acid and alcohol functionality. Illustrative of such branching components are tricarboxylic acids, such as trimesic acid, and lower alkyl esters thereof, and the like; tetracarboxylic acids, such as pyromellitic acid, and lower alkyl esters thereof, and the like; or preferably, polyols, and especially preferably, tetrols, such as pentaerythritol; triols, such as trimethylolpropane; dihydroxy carboxylic acids; and hydroxydicarboxylic acids and derivatives, such as dimethyl hydroxyterephthalate, and the like. Branched poly(alkylene terephthalate) resins and their preparation are described, for example, in U.S. Pat. No. 3,953,404 to Borman. In addition to terephthalic acid units, small amounts, e.g., from 0.5 to 15 mole percent of other aromatic dicarboxylic acids, such as isophthalic acid or naphthalene dicarboxylic acid, or aliphatic dicarboxylic acids, such as adipic acid, can also be present, as well as a minor amount of diol component other than that derived from 1,4-butanediol, such as ethylene glycol or cyclohexylenedimethanol, etc., as well as minor amounts of trifunctional, or higher, branching components, e.g., pentaerythritol, trimethyl trimesate, and the like.

The polyesters in one embodiment of the present invention may be a polyether ester block copolymer consisting of a thermoplastic polyester as the hard segment and a polyalkylene glycol as the soft segment. It may also be a three-component copolymer obtained from at least one dicarboxylic acid selected from: aromatic dicarboxylic acids such as terephthalic acid, isophthalic acid, phthalic acid, naphthalene-2,6-dicarboxylic acid, naphthalene-2,7-dicarboxylic acid, diphenyl-4,4-dicarboxylic acid, diphenoxyethanedicarboxylic acid or 3-sulfoisophthalic acid, alicyclic dicarboxylic acids such as 1,4-cyclohexanedicarboxylic acid, aliphatic dicarboxylic acids such as succinic acid, oxalic acid, adipic acid, sebacic acid, dodecanedicarboxylic acid or dimeric acid, and ester-forming derivatives thereof; at least one diol selected from: aliphatic diols such as 1,4-butanediol, ethylene glycol, trimethylene glycol, tetramethylene glycol, pentamethylene glycol, hexamethylene glycol, neopentyl glycol or decamethylene glycol, alicyclic diols such as 1,1-cyclohexanedimethanol, 1,4-cyclohexanedimethanol or tricyclodecanedimethanol, and ester-forming derivatives thereof; and at least one poly(alkylene oxide) glycol selected from: polyethylene glycol or poly(1,2- and 1,3-propylene oxide) glycol with an average molecular weight of about 400-5000, ethylene oxide-propylene oxide copolymer, and ethylene oxide-tetrahydrofuran copolymer.

The polyester can be present in the composition at about 1 to about 99 weight percent, based on the total weight of the composition. Within this range, it is preferred to use at least about 25 weight percent, even more preferably at least about 30 weight percent of the polyester. The preferred polyesters are preferably have an intrinsic viscosity (as measured in 60:40 solvent mixture of phenol/tetrachloroethane at 25° C.) ranging from about 0.1 to about 1.5 deciliters per gram. Polyesters branched or unbranched and generally will have a weight average molecular weight of from about 5,000 to about 150,000, preferably from about 8,000 to about 95,000 as measured by gel permeation chromatography using 95:5 weight percent of Chloroform to Hexafluroisopropanol mixture.

The polyester component may be prepared by procedures well known to those skilled in this art, such as by condensation reactions. The condensation reaction may be facilitated by the use of a catalyst, with the choice of catalyst being determined by the nature of the reactants. The various catalysts for use herein are very well known in the art and are too numerous to mention individually herein. Generally, however, when an alkyl ester of the dicarboxylic acid compound is employed, an ester interchange type of catalyst is preferred, such as Ti(OC₄H₉)₆ in n-butanol.

In one embodiment, the compositions of the invention may contain just about required amount of impact modifier that enables to retain transparency described by a value of transmission greater than about 60%.

The composition of the invention does not contain an appreciable amount of impact modifiers, such as polyethylene, polypropylene, MBS, ABS, acrylic rubbers, ethylene-glycidyl methacrylate copolymers, ethylene-acrylic acid ionomers, polyisoprene, polybutadiene or polyalkylene ether glycols or core-shell impact modifers. In one embodiment, the amount of the said impact modifiers is less than about 5%. In one embodiment, the amount of the said impact modifiers is less than about 2%. In one embodiment, there is no said impact modifier in the composition of the invention. An appreciable amount of impact modifier would refer to an amount exceeding 5 percent.

In one embodiment of the present invention the thermoplastic resin composition may optionally comprise stabilizing additives. In another embodiment the stabilizing additives may be a quenchers are used in the present invention to stop the polymerization reaction. Quenchers are agents inhibit activity of any catalysts that may be present in the resins to prevent an accelerated interpolymerization and degradation of the thermoplastic. The suitability of a particular compound for use as a stabilizer and the determination of how much is to be used as a stabilizer may be readily determined by preparing a mixture of the polyester resin component and the polycarbonate and determining the effect on melt viscosity, gas generation or color stability or the formation of interpolymer. In one embodiment of the quenchers are for example of phosphorous containing compounds, boric containing acids, aliphatic or aromatic carboxylic acids i.e., organic compounds the molecule of which comprises at least one carboxy group, anhydrides, polyols.

In one embodiment of the present invention a catalyst may be employed. The catalyst can be any of the catalysts commonly used in the prior art such as alkaline earth metal oxides such as magnesium oxides, calcium oxide, barium oxide and zinc oxide; alkali and alkaline earth metal salts; a Lewis catalyst such as tin or tinanium compounds; a nitrogen-containing compound such as tetra-alkyl ammonium hydroxides used like the phosphonium analogues, e.g., tetra-alkyl phosphonium hydroxides or acetates. The Lewis acid catalysts and the catalysts can be used simultaneously.

Inorganic compounds such as the hydroxides, hydrides, amides, carbonates, phosphates, borates, etc., of alkali metals such as sodium, potassium, lithium, cesium, etc., and of alkali earth metals such as calcium, magnesium, barium, etc., can be cited such as examples of alkali or alkaline earth metal compounds. Examples include sodium stearate, sodium carbonate, sodium acetate, sodium bicarbonate, sodium benzoate, sodium caproate, or potassium oleate.

In one embodiment of the invention, the catalyst is selected from one of phosphonium salts or ammonium salts (not being based on any metal ion) for improved hydrolytic stability properties. In another embodiment of the invention, the catalyst is selected from one of: a sodium stearate, a sodium benzoate, a sodium acetate, and a tetrabutyl phosphonium acetate. In yet another embodiment of the present invention the catalysts is selected independently from a group of sodium stearate, zinc stearate, calcium stearate, magnesium stearate, sodium acetate, calcium acetate, zinc acetate, magnesium acetate, manganese acetate, lanthanum acetate, lanthanum acetylacetonate, sodium benzoate, sodium tetraphenyl borate, dibutyl tinoxide, antimony trioxide, sodium polystyrenesulfonate, PBT-ionomer, titanium isoproxide and tetraammoniumhydrogensulfate and mixtures thereof. In an alternative embodiment the here said catalyst may be a compound of the form M(OR¹⁰)_{q} where M is an alkaline earth or akline metal, metal or transitional metals such as sodium, potassium, lithium, cesium, etc., and of alkali earth metals such as calcium, magnesium, barium, etc. metals and transitional metals like aluminium, magnesium, manganese, zinc, titanium, nickel and R¹⁰ can be an aliphatic or aromatic organic compound such as methyl, ethyl, propyl, phenyl etc and q is the valence of the metal corresponding to the compound.

In one embodiment the catalysts include, but are not limited to metal salts and chelates of Ti, Zn, Ge, Ga, Sn, Ca, Li and Sb. Other known catalysts may also be used for this step-growth polymerization. The choice of catalyst being determined by the nature of the reactants. In one embodiment of the present invention the reaction mixture comprises at least two catalysts. The various catalysts for use herein are very well known in the art and are too numerous to mention individually herein. A few examples of the catalysts which may be employed in the above process include but are not limited to titanium alkoxides. such as tetramethyl, tetraethyl, tetra(n-propyl), tetraisopropyl and tetrabutyl titanates; dialkyl tin compounds, such as di-(n-butyl) tin dilaurate. di-(n-butyl) tin oxide and di-(n-butyl) tin diacetate; and oxides. acetate salts and sulfate salts of metals, such as magnesium, calcium, germanium, zinc, antimony, etc. In one embodiment the catalyst is titanium alkoxides. The catalyst level is employed in an effective amount to enable the copolymer formation and is not critical and is dependent on the catalyst that is used. Generally the catalyst is used in concentration ranges of about 10 to about 500 ppm, preferably about is less than about 300 ppm and most preferably about 20 to about 300 ppm.

In another embodiment a catalyst quencher may optionally be added to the reaction mixture. The choice of the quencher is essential to avoid color formation and loss of clarity of the thermoplastic composition. In one embodiment of the invention, the catalyst quenchers are phosphorus containing derivatives, examples include but are not limited to diphosphites, phosphonates, metaphosphoric acid; arylphosphinic and arylphosphonic acids; polyols; carboxylic acid derivatives and combinations thereof. The amount of the quencher added to the thermoplastic composition is an amount that is effective to stabilize the thermoplastic composition. In one embodiment the amount is at least about 0.001 weight percent, preferably at least about 0.01 weight percent based on the total amounts of said thermoplastic resin compositions. The amount of quencher used is thus an amount which is effective to stabilize the composition therein but insufficient to substantially deleteriously affect substantially most of the advantageous properties of said composition.

The composition of the present invention may further include additives which do not interfere with the previously mentioned desirable properties but enhance other favorable properties such as anti-oxidants, reinforcing materials, colorants, mold release agents, fillers, nucleating agents, UV light and heat stabilizers, lubricants, and the like.

Other additional ingredients may include antioxidants, and UV absorbers, and other stabilizers. Antioxidants include i) alkylated monophenols, for example: 2,6-di-tert-butyl-4-methylphenol, 2-tert-butyl-4,6-dimethylphenol, 2,6-di-tert-butyl-4-ethylphenol, 2,6-di-tert-butyl-4-n-butylphenol, 2,6-di-tert-butyl-4-isobutylphenol, 2,6-dicyclopentyl-4-methylphenol, 2-(alpha-methylcyclohexyl)-4,6 dimethylphenol, 2,6-di-octadecyl-4-methylphenol, 2,4,6,-tricyclohexyphenol, 2,6-di-tert-butyl-4-methoxymethylphenol; ii) alkylated hydroquinones, for example, 2,6-di-tert-butyl-4-methoxyphenol, 2,5-di-tert-butyl-hydroquinone, 2,5-di-tert-amyl-hydroquinone, 2,6-diphenyl-4octadecyloxyphenol; iii) hydroxylated thiodiphenyl ethers; iv) alkylidene-bisphenols; v) benzyl compounds, for example, 1,3,5-tris-(3,5-di-tert-butyl-4-hydroxybenzyl)-2,4,6-trimethylbenzene; vi) acylaminophenols, for example, 4-hydroxy-lauric acid anilide; vii) esters of beta-(3,5-di-tert-butyl-4-hydroxyphenol)-propionic acid with monohydric or polyhydric alcohols; viii) esters of beta-(5-tert-butyl-4-hydroxy-3-methylphenyl)-propionic acid with monohydric or polyhydric alcohols; vii) esters of beta-(5-tert-butyl-4-hydroxy-3-methylphenyl)propionic acid with mono- or polyhydric alcohols, e.g., with methanol, diethylene glycol, octadecanol, triethylene glycol, 1,6-hexanediol, pentaerythritol, neopentyl glycol, tris(hydroxyethyl)isocyanurate, thiodiethylene glycol, N,N-bis(hydroxyethyl)oxalic acid diamide. Typical, UV absorbers and light stabilizers include i) 2-(2′-hydroxyphenyl)-benzotriazoles, for example, the 5′methyl-,3′5′-di-tert-butyl-,5′-tert-butyl-,5′(1,1,3,3-tetramethylbutyl)-,5-chloro-3′,5′-di-tert-butyl-,5-chloro-3′tert-butyl-5′methyl-,3′sec-butyl-5′tert-butyl-,4′-octoxy,3′,5′-ditert-amyl-3′,5′-bis-(alpha,alpha-dimethylbenzyl)-derivatives; ii) 2.2 2-Hydroxy-benzophenones, for example, the 4-hydroxy-4-methoxy-,4-octoxy,4-decloxy-,4-dodecyloxy-,4-benzyloxy,4,2′,4′-trihydroxy- and 2′hydroxy-4,4′-dimethoxy derivative, and iii) esters of substituted and unsubstituted benzoic acids for example, phenyl salicylate, 4-tert-butylphenyl-salicilate, octylphenyl salicylate, dibenzoylresorcinol, bis-(4-tert-butylbenzoyl)-resorcinol, benzoylresorcinol, 2,4-di-tert-butyl-phenyl-3,5-di-tert-butyl-4-hydroxybenzoate and hexadecyl-3,5-di-tert-butyl-4-hydroxybenzoate.

The composition can further comprise one or more anti-dripping agents, which prevent or retard the resin from dripping while the resin is subjected to burning conditions. Specific examples of such agents include silicone oils, silica (which also serves as a reinforcing filler), asbestos, and fibrillating-type fluorine-containing polymers. Examples of fluorine-containing polymers include fluorinated polyolefins such as, for example, poly(tetrafluoroethylene), tetrafluoroethylene/hexafluoropropylene copolymers, tetrafluoroethylene/ethylene copolymers, polyvinylidene fluoride, poly(chlorotrifluoroethylene), and the like, and mixtures comprising at least one of the foregoing anti-dripping agents. A preferred anti-dripping agent is poly(tetrafluroethylene). When used, an anti-dripping agent is present in an amount of about 0.02 to about 2 weight percent, and more preferably from about 0.05 to about 1 weight percent, based on the total weight of the composition.

Dyes or pigments may be used to give a background coloration. Dyes are typically organic materials that are soluble in the resin matrix while pigments may be organic complexes or even inorganic compounds or complexes, which are typically insoluble in the resin matrix. These organic dyes and pigments include the following classes and examples: furnace carbon black, titanium oxide, zinc sulfide, phthalocyanine blues or greens, anthraquinone dyes, scarlet 3b Lake, azo compounds and acid azo pigments, quinacridones, chromophthalocyanine pyrrols, halogenated phthalocyanines, quinolines, heterocyclic dyes, perinone dyes, anthracenedione dyes, thioxanthene dyes, parazolone dyes, polymethine pigments and others.

From an aesthetic standpoint, the use of color pigments for special visual effects may be utilized. Such ingredients may include a metallic-effect pigment, a metal oxide-coated metal pigment, a platelike graphite pigment, a platelike molybdenumdisulfide pigment, a pearlescent mica pigment, a metal oxide-coated mica pigment, an organic effect pigment a layered light interference pigment, a polymeric holographic pigment or a liquid crystal interference pigment. Preferably, the effect pigment is a metal effect pigment selected from the group consisting of aluminum, gold, brass and copper metal effect pigments; especially aluminum metal effect pigments. Alternatively, preferred effect pigments are pearlescent mica pigments or a large particle size, preferably platelet type, organic effect pigment selected from the group consisting of copper phthalocyanine blue, copper phthalocyanine green, carbazole dioxazine, diketopyrrolopyrrole, iminoisoindoline, iminoisoindolinone, azo and quinacridone effect pigments.

Suitable colored pigments may be included in the resin blend. Such pigments include organic pigments selected from the group consisting of azo, azomethine, methine, anthraquinone, phthalocyanine, perinone, perylene, diketopyrrolopyrrole, thioindigo, dioxazine iminoisoindoline, dioxazine, iminoisoindolinone, quinacridone, flavanthrone, indanthrone, anthrapyrimidine and quinophthalone pigments, or a mixture or solid solution thereof; especially a dioxazine, diketopyrrolopyrrole, quinacridone, phthalocyanine, indanthrone or iminoisoindolinone pigment, or a mixture or solid solution thereof.

Colored organic pigments of particular interest include C.I. Pigment Red 202, C.I. Pigment Red 122, C.I. Pigment Red 179, C.I. Pigment Red 170, C.I. Pigment Red 144, C.I. Pigment Red 177, C.I. Pigment Red 254, C.I. Pigment Red 255, C.I. Pigment Red 264, C.I. Pigment Brown 23, C.I. Pigment Yellow 109, C.I. Pigment Yellow 110, C.I. Pigment Yellow 147, C.I. Pigment Orange 61, C.I. Pigment Orange 71, C.I. Pigment Orange 73, C.I. Pigment Orange 48, C.I. Pigment Orange 49, C.I. Pigment Blue 15, C.I. Pigment Blue 60, C.I. Pigment Violet 23, C.I. Pigment Violet 37, C.I. Pigment Violet 19, C.I. Pigment Green 7, C.I. Pigment Green 36, or a mixture or solid solution thereof.

Suitable colored pigments also include inorganic pigments; especially those selected from the group consisting of metal oxides, antimony yellow, lead chromate, lead chromate sulfate, lead molybdate, ultramarine blue, cobalt blue, manganese blue, chrome oxide green, hydrated chrome oxide green, cobalt green and metal sulfides, such as cerium or cadmium sulfide, cadmium sulfoselenides, zinc ferrite, bismuth vanadate and mixed metal oxides.

Most preferably, the colored pigment is a transparent organic pigment. Pigment compositions wherein the colored pigment is a transparent organic pigment having a particle size range of below 0.2 μm, preferably below 0.1 μm, are particularly interesting. For example, inventive pigment compositions containing, as transparent organic pigment, the transparent quinacridones in their magenta and red colors, the transparent yellow pigments, like the isoindolinones or the yellow quinacridone/quinacridonequinone solid solutions, transparent copper phthalocyanine blue and halogenated copper phthalocyanine green, or the highly-saturated transparent diketopyrrolopyrrole or dioxazine pigments are particularly interesting.

Typically the pigment composition is prepared by blending the pigment with the filler by known dry or wet mixing techniques. For example, the components are wet mixed in the end step of a pigment preparatory process, or by blending the filler into an aqueous pigment slurry, the slurry mixture is then filtered, dried and micropulverized.

In a preferred method, the pigment is dry blended with the filler in any suitable device which yields a nearly homogenous mixture of the pigment and the filler. Such devices are, for example, containers like flasks or drums which are submitted to rolling or shaking, or specific blending equipment like for example the TURBULA mixer from W. Bachofen, CH-4002 Basel, or the P-K TWIN-SHELL INTENSIFIER BLENDER from Patterson-Kelley Division, East Stroudsburg, Pa. 18301. The pigment compositions are generally used in the form of a powder which is incorporated into a high-molecular-weight organic composition, such as a coating composition, to be pigmented. The pigment composition consists of or consists essentially of the filler and colored pigment, as well as customary additives for pigment compositions. Such customary additives include texture-improving agents and/or antiflocculating agents.

Typically the additive is generally present in amount corresponding to about 0 to about 1.5 weight percent based on the amount of resin. In another embodiment the additive is generally present in amount corresponding to about 0.01 to about 0.5 weight percent based on the amount of resin.

The range of composition of the thermoplastic resin of the present invention is from about 90 to 10 weight percent of the polycarbonate component, 10 to about 90 percent by weight of the polyester component. In yet another embodiment the polycarbonate is present in an amount of at least about 40 weight percent. In one embodiment the polycarbonate is present in an amount in the range from about 90 and about 5 weight percent based on the total weight of the composition. In yet another embodiment the polycarbonate is present in an amount in the range of between about 80 and about 20 weight percent based on the total weight of the composition. In one embodiment, the composition comprises about 75-25 weight percent polycarbonate and 25-75 weight percent of the polyester component.

The composition of the present invention is a miscible composition. Miscible compositions are transparent, not opaque. In addition, differential scanning calorimetry testing detects only a single glass transition temperature (Tg) for miscible blends composed of two or more components. In one embodiment of the present invention the composition transmits about greater than 60 percent light in the region of about 400 nm to about 800 nm. In another embodiment the composition transmits in the range of between about 65 and about 99 percent light in the region of about 400 nm to about 800 nm.

In one embodiment of the present invention the composition are prepared by melt processes. The process may be a continuous polymerization process where in the said reaction is conducted in a continuous mode in a train of reactor of at least 2 reactors in series or in parallel and the here said reactants and additives inclusive of catalysts are all added in the first reactor or either in any of the reactor in the train. In an alternate embodiment the process may be a batch polymerization process where in the reaction is conducted in a batch mode either in a single vessel or in multiple vessels and the reaction can be conducted in two or more stages depending on the number of reactor and the process conditions. In an alternate embodiment, the process can be carried out in a semi continuous polymerization process where the reaction is carried out in a batch mode. In one embodiment the additives are added continuously. In another embodiment the reaction is conducted in a continuous mode where the polymer is removed continuously and the reactants or additives are added in a batch process.

In one embodiment of the present invention the process may be in one embodiment be carried out in an inert atmosphere. In another embodiment the process may be carried out in nitrogen, argon or carbon dioxide atmosphere. The inert atmosphere may be either nitrogen or argon or carbon dioxide. The heating of the various ingredients may be carried out in a temperature between about 90° C. and about 230° C. In one embodiment the blend of the present invention, polycarbonates, polyester, is polymerized by extrusion at a temperature ranging from about 225 to 350° C. for a sufficient amount of time to produce a composition characterized by a single Tg. In one embodiment the process may optionally be carried out at a pressure of about 0.01 kPa to atmospheric pressure. In yet another embodiment the vacuum is between 0.01 kPa to 80 kPa. In one embodiment the polyester is derived by transesterification of scrap polyethylene terephthalate (bottle scrap) with para-xylene glycol.

The reaction may be conducted optionally in presence of a solvent or in neat conditions without the solvent. The organic solvent used in the above process according to the invention should be capable of dissolving the polyester and polycarbonate to an extent of at least 0.01 g/per ml at 25° C. and should have a boiling point in the range of 140-290° C. at atmospheric pressure. Preferred examples of the solvent include but are not limited to amide solvents, in particular, N-methyl-2-pyrrolidone; N— acetyl-2-pyrrolidone; N,N′-dimethyl formamide; N,N′-dimethyl acetamide; N,N′-diethyl acetamide; N,N′-dimethyl propionic acid amide; N,N′-diethyl propionic acid amide; tetramethyl urea; tetraethyl urea; hexamethylphosphor triamide; N-methyl caprolactam and the like. Other solvents may also be employed, for example, methylene chloride, chloroform, 1,2-dichloroethane, tetrahydrofuran, diethyl ether, dioxane, benzene, toluene, chlorobenzene, o-dichlorobenzene and the like.

In one embodiment the composition may be made by conventional blending techniques. The production of the compositions may utilize any of the blending operations known for the blending of thermoplastics, for example blending in a kneading machine such as a Banbury mixer or an extruder. To prepare the composition, the components may be mixed by any known methods. Typically, there are two distinct mixing steps: a premixing step and a melt mixing step. In the premixing step, the dry ingredients are mixed together. The premixing step is typically performed using a tumbler mixer or ribbon blender. However, if desired, the premix may be manufactured using a high shear mixer such as a Henschel mixer or similar high intensity device. The premixing step is typically followed by a melt mixing step in which the premix is melted and mixed again as a melt. Alternatively, the premixing step may be omitted, and raw materials may be added directly into the feed section of a melt mixing device, preferably via multiple feeding systems. In the melt mixing step, the ingredients are typically melt kneaded in a single screw or twin screw extruder, a Banbury mixer, a two roll mill, or similar device.

In one embodiment of the present invention the composition could be prepared by solution method. The solution method involves dissolving all the ingredients in a common solvent (or) a mixture of solvents and either precipitation in a non-solvent or evaporating the solvent either at room temperature or a higher temperature of at least about 50° C. to about 80° C. In one embodiment, the reactants can be mixed with a relatively volatile solvent, preferably an organic solvent, which is substantially inert towards the polymer, and will not attack and adversely affect the polymer. Some suitable organic solvents include ethylene glycol diacetate, butoxyethanol, methoxypropanol, the lower alkanols, chloroform, acetone, methylene chloride, carbon tetrachloride, tetrahydrofuran, and the like. In one embodiment of the present invention the non solvent is at least one selected from the group consisting of mono alcohols such as ethanol, methanol, isopropanol, butanols and lower alcohols with C1 to about C12 carbon atoms. In one embodiment the solvent is chloroform.

In one embodiment, the ingredients are pre-compounded, pelletized, and then molded. Pre-compounding can be carried out in conventional equipment. For example, after pre-drying the polyester composition (e.g., for about four hours at about 120° C.), a single screw extruder may be fed with a dry blend of the ingredients, the screw employed having a long transition section to ensure proper melting. Alternatively, a twin screw extruder with intermeshing co-rotating screws can be fed with resin and additives at the feed port and reinforcing additives (and other additives) may be fed downstream. The pre-compounded composition can be extruded and cut up into molding compounds such as conventional granules, pellets, and the like by standard techniques. The composition can then be molded in any equipment conventionally used for thermoplastic compositions, such as a Newbury type injection molding machine with conventional cylinder temperatures, at about 230° C. to about 280° C., and conventional mold temperatures at about 55° C. to about 95° C.

The molten mixture of the polyester may be obtained in particulate form, example by pelletizing or grinding the composition. The composition of the present invention can be molded into useful articles by a variety of means by many different processes to provide useful molded products such as injection, extrusion, rotation, foam molding calender molding and blow molding and thermoforming, compaction, melt spinning form articles. Non limiting examples of the various articles that could be made from the thermoplastic composition of the present invention include electrical connectors, electrical devices, computers, building and construction, outdoor equipment. The articles made from the composition of the present invention may be used widely in house ware objects such as food containers and bowls, home appliances, as well as films, electrical connectors, electrical devices, computers, building and construction, outdoor equipment, trucks and automobiles. In one embodiment the polyester may be blended with other conventional polymers.

### EXAMPLES

Without further elaboration, it is believed that one skilled in the art can, using the description herein, utilize the present invention to its fullest extent. The following examples are included to provide additional guidance to those skilled in the art in practicing the claimed invention. The examples provided are merely representative of the work that contributes to the teaching of the present application. While only certain features of the invention have been illustrated and described herein, many modifications and changes will occur to those skilled in the art. Accordingly, these examples are not intended to limit the invention, as defined in the appended claims, in any manner.

In the following examples values for glass transition temperatures (Tg) were determined by differential scanning calorimetry (DSC) at a heating rate of 20° C. per minute. Weight average molecular weights were measured by gel permeation chromatography (GPC) versus polystyrene standards using chloroform as solvent. The GPC column was a Mixed-C column with dimensions 300 millimeters (mm)×7.5 mm available from Polymer Laboratories. Yellow index or YI was measured on a Gardner Colorimeter model XL-835. The percentage transmission and haze were determined in accordance with test method ASTM D-1003. Chemical resistance was evaluated according to ISO 4599 on an extruded test piece (thickness=2.5 mm) was secured in 1% distortion jig and exposed various solvents for two days and the elongation at break was measured. The tensile properties like Yield stress, Yield strain, Break stress, Break strain were determined on Instron using ISO 527 standard. Visual examination was carried out to note for any appearance changes, crazes, cracks, discoloration etc.

TABLE 1
Abbreviation

| | |
|---|---|
| DMCD | 1,4-dimethyl cyclohexane |
| CHDM | 1,4-cyclohexane dimethanol |
| PXG | Para-xylene glycol |
| BDO | Butane diol |
| DMT | Dimethyl terephthalate |
| PCT | Poly(1,4-cyclohexyl dimethylene terephthalate) |
| PBT | Poly(butylene terephthalate) |
| PXBT-50 | A copolyester prepared from dimethyl terephthalate, |
| | butane diol (50 mole %) and p-xylene glycol |
| | (50 mole %). |
| DEDA-TPA | Bis(4-carboethoxy)1,4-diphenyl terephthalamide |
| DEDA-CHDA | Bis(4-carboethoxy)1,4-diphenyl cyclohexylamide |
| T_{g} | Glass Transition Temperature |
| Tₘ | Melting Temperature |
| T_{Cr} | Crystallization Temperature |
| I.V | Intrinsic Viscosity |

Preparation of PXI and PXD: General Procedure

The polymerization reaction was conducted in a cylindrical glass reactor equipped with side arm, a mechanical stirrer driven by an overhead stirring motor and a small side arm with stopcock. The ingredients PXG, DMI and DMCD were taken in the reactor and the side arm was used to purge nitrogen gas as well as for applying vacuum. The reactor was evacuated and purged with nitrogen for three times to remove the traces of oxygen and moisture. The reactor was purged with nitrogen and brought to atmospheric pressure and the contents were heated till a clear melt was obtained and was kept under nitrogen under constant stirring conditions of about 100 rotation per minute. Through the small side arm 200 ppm of titanium (IV) isopropoxide was added as a catalyst at 180° C. and the ester interchange reaction proceeded with the distillation methanol through the side arm. The temperature of the melt was increased in a stepwise manner from 180° C. to 200° C. to 230° C. and then to 250° C. and stirred for about 1 hour under nitrogen. The pressure in the reactor was decreased in stepwise manner from about 900 mm Hg to 700, 500, 300, 100, 50, 25 10 mbar at a temperature of about 250° C. Vacuum of about 0.5 to 0.1 mm bar applied was applied and the polymerization was continued for about 30 to 45 minutes. After completion of the polymerization the pressure inside the reactor was taken to atmospheric pressure by purging nitrogen. The polymer was collected by applying the nitrogen gas pressure and the polymers were obtained as a wire by breaking the nipple at the bottom of the reactor. The polymer was dissolved in PhOH/TCE (3/2) solvent mixture at room temperature for half an hour and inherent viscosity was measured at 25° C.

Preparation of Blends: Solution Method

Examples 1 to 8: The blends were made with polycarbonate available from General Electric Company as Lexan® polycarbonate resin with the PXI/PXD polyesters. The blends were obtained by solvent cast method. Known amounts of polyester and PC were dissolved in chloroform solvent (50 ml) to form a homogeneous solution. The solution was allowed to evaporate at room temperature. The films were dried in vacuum at moderate temperatures of about 50-60° C. for about 12 hours to ensure that all the solvent had evaporated. The glass transition temperature (Tg) of the blends prepared was recorded on films and the Tg values were recorded on second run. The data is given in Tables 1. The blends have a glass transition temperature in the range of about 90° C. to about 122° C. depending upon the composition of the blend.

Preparation of Blends: Melt Method

Examples 9 to 12: Blends were made with polycarbonate available from General Electric Company as Lexan® polycarbonate resin blended with the PXI/PXD polyesters. The blends were obtained by mixing known amounts of polycarbonate and polyesters by weights. The melt blending was carried out using melt mixture instrument, which has a cavity along with piston for mixing the blend at the set temperature. The instrument was preheated to 260° C. and blend mixture was poured into the cavity. It was allowed to melt in air and mixed with stirring with piston for 3 minutes. The blend melt was pressed with piston and it was obtained as a clear strand with a slight color. The glass transition temperature (Tg) of blends prepared was recorded on strands and the Tg values were recorded on second run. The data is given in Tables 1 and 2. The blends have a glass transition temperature in the range of about 90° C. to about 122° C. depending upon the composition of the blend. (Inventors: please include the experimental wherein u use the catalyst)

The intrinsic viscosity of the polymer was measured using a Ubhellode Viscometer with Phenol Tetra chloroethane mixture of 60:40 ration by weight and the measurements were carried out at 25° C.

TABLE 2

| | | | | T_{g} | T_{g} |
|---|---|---|---|---|---|
| | PC | PXI | PXD | Experimental^{#} (° C.) | Calculated* (° C.) |
| C. Ex. 1 | 100 | — | — | 145 | — |
| C. Ex. 2 | — | 100 | — | 80 | — |
| C. Ex. 3 | — | — | 100 | 55 | — |
| Ex. 1 | 20 | 80 | — | 90 | 94 |
| Ex. 2 | 40 | 60 | — | 99 | 108 |
| Ex. 3 | 60 | 40 | — | 113 | 122 |
| Ex. 4 | 80 | 20 | — | 121 | 136 |
| Ex. 5 | 20 | — | 80 | 73 | 76 |
| Ex. 6 | 40 | — | 60 | 91 | 94 |
| Ex. 7 | 60 | — | 40 | 108 | 113 |
| Ex. 8 | 80 | — | 20 | 121 | 132 |

*obtained based on composition Table 3

TABLE 3

| | | | | T_{g} | T_{g} |
|---|---|---|---|---|---|
| | PC | PXI | PXD | Experimental(° C.) | Calculated* (° C.) |
| C. Ex. 1 | 100 | — | — | 145 | — |
| C. Ex. 2 | — | 100 | — | 80 | — |
| C. Ex. 3 | — | — | 100 | 55 | — |
| Ex. 9 | 20 | 80 | — | 85 | 94 |
| Ex. 10 | 40 | 60 | — | 87 | 108 |
| Ex. 11 | 80 | 20 | — | 126 | 136 |
| Ex. 12 | 20 | — | 80 | 69 | 76 |
| Ex. 13 | 40 | — | 60 | 85 | 94 |
| Ex. 14 | 80 | — | 20 | 126 | 132 |

*Obtained based on composition

The blends of PXI and PXD with PC obtained by solution and melt methods are shown in Table 2 and 3. All the blends obtained by both the methods showed a single Tg, which is an indicative of the miscibility of these polyesters with polycarbonate. In the compositions, as the concentration of PC increased from 20%-80% the Tg of the blend increased linearly.

TABLE 4

| | C. Ex. 4 | C. Ex. 5 | Ex. 15 | Ex. 16 |
|---|---|---|---|---|
| PC | 74.6 | 74.6 | 74.6 | 75.0 |
| PCCD | 25.0 | | | |
| PCTG | | 25.0 | | |
| PXD | | | 25.0 | |
| PXBT-50 | | | | 25.0 |
| % Transmission | 89.3 | 90 | 85 | 82 |
| Tensile Strength (MPa) | 54 | 60 | 61 | 61 |
| Tensile Modulus (MPa) | 1980 | 2300 | 2320 | 2230 |
| Elongation @ Break (%) | 100 | 65 | 95 | 110 |
| Tensile Properties in Ethanol under | | | | |
| 0.5% Strain for 48 hrs | | | | |
| full immersion | | | | |
| Tensile Strength (MPa) | 53 | 60 | 60 | |
| Tensile Modulus (MPa) | 1920 | 2200 | 2100 | |
| Elongation @ Break | 95 | 59 | 85 | |
| (%) | | | | |
| Retention of Elongation at Break | 95 | 90.8 | 89.5 | |
| (%) | | | | |
| Tensile Properties in Isopropanol | | | | |
| under 0.5% Strain for 48 hrs | | | | |
| full immersion | | | | |
| Tensile Strength (MPa) | 53 | 60 | 61 | |
| Tensile Modulus (MPa) | 1860 | 2260 | 2210 | |
| Elongation @ Break (%) | 25 | 49 | 90 | |
| Retention of Elongation at Break | 25.0 | 75.4 | 94.7 | |
| (%) | | | | |

The blend compositions along with the properties are shown in Table 4. All the blends obtained showed transparency, which is an indicative of the miscibility of these polyesters with polycarbonate. From the table 4, it is evident that the formulations with PCCD and PCTG as a polyester with PC has good tensile strength and elongation at break while the blend of PXD and PC shows better chemical resistance in isopropanol than PCCD and PCTG blends with PC while maintaining its transparency. PXBT which is a copolyester also forms a transparent blend with polycarbonate (Ex. 16). No visible cracks were observed when the composition of Ex. 16 was exposed to oleic acid.

While the invention has been illustrated and described in typical embodiments, it is not intended to be limited to the details shown, since various modifications and substitutions can be made without departing in any way from the spirit of the present invention. As such, further modifications and equivalents of the invention herein disclosed may occur to persons skilled in the art using no more than routine experimentation, and all such modifications and equivalents are believed to be within the spirit and scope of the invention as defined by the following claims. All Patents and published articles cited herein are incorporated herein by reference.

1. A thermoplastic resin composition comprising:
(a) at least one substituted or unsubstituted polycarbonate
(b) a polyester comprising structural units derived from at least greater than 40 mole percent of xylene glycol;
wherein said composition is miscible.

2. The composition of claim 1, wherein the composition does not contain an appreciable amount of an impact modifier selected from the group consisting of polyethylene, polypropylene, NBS, ABS, acrylic rubbers, ethylene-glycidyl methacrylate copolymers, ethylene-acrylic acid ionomers, polyisoprene, polybutadiene or polyalkylene ether glycols.

3. The composition of claim 1, wherein said polycarbonate comprises repeating units of the formula: 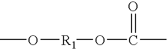
wherein R₁ is a divalent aromatic radical derived from a dihydroxyaromatic compound of the formula HO-D-OH, wherein D has the structure of formula: 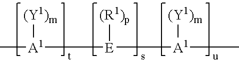
wherein A¹ represents an aromatic group; E comprises a sulfur-containing linkage, sulfide, sulfoxide, sulfone; a phosphorus-containing linkage, phosphinyl, phosphonyl; an ether linkage; a carbonyl group; a tertiary nitrogen group; a silicon-containing linkage; silane; siloxy; a cycloaliphatic group;
cyclopentylidene, cyclohexylidene, 3,3,5-trimethylcyclohexylidene, methylcyclohexylidene, 2-[2.2.1]-bicycloheptylidene, neopentylidene, cyclopentadecylidene, cyclododecylidene, adamantylidene; an alkylene or alkylidene group, which group may optionally be part of one or more fused rings attached to one or more aromatic groups bearing one hydroxy substituent; an unsaturated alkylidene group; or two or more alkylene or alkylidene groups connected by a moiety different from alkylene or alkylidene and selected from the group consisting of an aromatic linkage, a tertiary nitrogen linkage; an ether linkage; a carbonyl linkage; a silicon-containing linkage, silane, siloxy; a sulfur-containing linkage, sulfide, sulfoxide, sulfone; a phosphorus-containing linkage, phosphinyl, and phosphonyl;
R¹ independently at each occurrence comprises a mono-valent hydrocarbon group, alkenyl, allyl, alkyl, aryl, aralkyl, alkaryl, or cycloalkyl;
Y¹ independently at each occurrence is selected from the group consisting of an inorganic atom, a halogen; an inorganic group, a nitro group; an organic group, a monovalent hydrocarbon group, alkenyl, allyl, alkyl, aryl, aralkyl, alkaryl, cycloalkyl, and an alkoxy group;
the letter “m” represents any integer from and including zero through the number of replaceable hydrogens on A¹ available for substitution;
the letter “p” represents an integer from and including zero through the number of replaceable hydrogens on E available for substitution;
the letter “t” represents an integer equal to at least one;
the letter “s” represents an integer equal to either zero or one; and
“u” represents any integer including zero.

4. The composition of claim 3, wherein the dihydroxy aromatic compound from which D is derived is bisphenol A.

5. The composition of claim 1, wherein the polyester is derived from structural units comprising at least one substituted or unsubstituted diacid and xylene glycol.

6. The composition of claim 5, wherein the diacid is at least one selected from the group consisting of linear acids, terephthalic acids, isophthalic acids, phthalic acids, naphthalic acids, cycloaliphatic acids, bicyclo aliphatic acids, decahydro naphthalene dicarboxylic acids, norbornene dicarboxylic acids, bicyclo octane dicarboxylic acids, 1,4-cyclohexanedicarboxylic acid, adipic acid, azelaic acid, dicarboxyl dodecanoic acid, stilbene dicarboxylic acid and succinic acid and their chemical equivalents.

7. The composition of claim 1, wherein the xylene glycol is selected from the group consisting of ortho-xylene glycol, meta-xylene glycol, para-xylene glycol, and mixtures thereof.

8. The composition of claim 7, wherein the xylene glycol is para-xylene glycol.

9. The composition of claim 1, wherein the polyester comprises xylene glycol in a range between about 45 mole percent and about 100 mole percent of the diol.

10. The composition of claim 1, wherein the polyester may optionally comprise structural units selected from the group consisting of ethylene glycol; propylene glycol, butanediol, pentane diol; dipropylene glycol; 2-methyl-1,5-pentane diol; 1,6-hexane diol; decalin dimethanol, bicyclo octane dimethanol; 1,4-cyclohexane dimethanol; triethylene glycol; 1,10-decane diol; tricyclodecane dimethanol;
hydrogenated bisphenol-A, tetramethyl cyclobutane diol, their chemical equivalents, and combinations thereof.

11. The composition of claim 1, wherein the polyester is present in an amount ranging from about 10 and about 90 weight percent, based on the total weight of the composition.

12. The composition of claim 1, wherein the polyester is present in an amount ranging from about 20 and about 80 weight percent, based on the total weight of the composition.

13. The composition of claim 1, wherein the polycarbonate is present in an amount ranging from about 90 and about 10 weight percent, based on the total weight of the composition.

14. The composition of claim 1, wherein the polycarbonate is present in an amount ranging from about 80 and about 20 weight percent, based on the total weight of the composition.

15. The composition of claim 1, wherein the composition further comprises an additive.

16. The composition of claim 15, wherein the additive is present in an amount ranging from about 0 to 1.5 weight percent, based on the total weight of the thermoplastic resin.

17. The composition of claim 1, wherein the composition is resistant to deterioration from contact with organic alcohols.

18. The composition of claim 1, wherein the composition has a glass transition temperature ranging from about 50° C. to about 130° C.

19. A composition comprising an article molded from the composition of claim 1.

20. A process to prepare a thermoplastic resin composition comprising:
(a) at least one substituted or unsubstituted polycarbonate
(b) a polyester comprising structural units derived from at least greater than 40 mole percent of xylene glycol; and
wherein the composition is miscible and wherein the composition does not contain an appreciable amount of an impact modifier selected from the group consisting of polyethylene, polypropylene, MBS, ABS, acrylic rubbers, ethylene-glycidyl methacrylate copolymers, ethylene-acrylic acid ionomers, polyisoprene, polybutadiene or polyalkylene ether glycols; and wherein the process comprises the steps of:
i. mixing the polycarbonate and polyester to form a first mixture;
ii. heating the first mixture to form the composition.

21. The process of claim 20, wherein the process is carried out in presence of a catalyst.

22. The process of claim 20, wherein the catalyst is selected from the group consisting of alkali metal and alkaline earth metal salts of aromatic dicarboxylic acids, alkali metal and alkaline earth metal salts of aliphatic dicarboxylic acids, Lewis acids, metal oxides, coordination complexes of the foregoing, and combinations thereof.

23. The process of claim 20, wherein the process is carried out in presence of a solvent.

24. A thermoplastic resin composition consisting essentially of:
(a) structural units derived from at least one substituted or unsubstituted polycarbonate,
(b) a polyester comprising structural units derived from at least greater than 40 mole percent of xylene glycol;
wherein the composition is miscible.

25. A thermoplastic resin composition consisting essentially of:
(a) structural units derived from at least one substituted or unsubstituted polycarbonate,
(b) a polyester comprising structural units derived from at least greater than 45 mole percent of xylene glycol and at least one diacid selected from the group consisting of terephthalic acids, isophthalic acids, phthalic acids, naphthalic acids, cycloaliphatic acids, bicyclo aliphatic acids, decahydro naphthalene dicarboxylic acids, norbornene dicarboxylic acids, bicyclo octane dicarboxylic acids, 1,4-cyclohexanedicarboxylic acid, adipic acid, azelaic acid, dicarboxyl dodecanoic acid, stilbene dicarboxylic acid and succinic acid and their chemical equivalents
wherein the composition is miscible.
